(19) United States
(12) Patent Application Publication
(10) Pub. No.: US 2024/0092139 A1
(43) Pub. Date: Mar. 21, 2024

(54) HEATING, VENTILATION, AND AIR CONDITIONER FOR AN ELECTRIC VEHICLE

(71) Applicants: HYUNDAI MOTOR COMPANY, Seoul (KR); KIA CORPORATION, Seoul (KR)

(72) Inventor: Nam-Seok Yun, Hwaseong-si (KR)

(73) Assignees: HYUNDAI MOTOR COMPANY, Seoul (KR); KIA CORPORATION, Seoul (KR)

(21) Appl. No.: 18/097,801

(22) Filed: Jan. 17, 2023

(30) Foreign Application Priority Data
Sep. 20, 2022 (KR) 10-2022-0118823

(51) Int. Cl. B60H 1/00

(52) U.S. Cl. CPC B60H 1/00385; B60H 1/00278; B60H 1/00285; B60H 1/00907

(57) ABSTRACT

Disclosed is heating, ventilation, and air conditioner (HVAC) of an electric vehicle. The HVAC includes: a compressor configured to compress a refrigerant, a four-way reversing valve connected to four flow paths including a flow path connected to a discharge end of the compressor and a flow path connected to a suction end of the compressor, a first heat exchanger connected to the four-way reversing valve and configured to operate as a condenser or an evaporator according to a circulation direction of the refrigerant, and a second heat exchanger of which one end is connected to the first heat exchanger and the other end is connected to the four-way reversing valve and which operates as a condenser or an evaporator according the circulation direction of the refrigerant.

### CROSS-REFERENCE(S) TO RELATED APPLICATION

This application claims priority to and the benefit of Korean Patent Application No. 10-2022-0118823, filed on Sep. 20, 2022, the disclosure of which is incorporated herein by reference in its entirety.

### FIELD

The present disclosure relates to a heating, ventilation, and air conditioner (HVAC) applied to an electric vehicle, particularly a small electric bus.

### BACKGROUND

A heat pump system using an inside condenser in a heating, ventilation, and air conditioner (HVAC), which uses a three-way valve and power electric (PE) & battery waste heat as a heat source in passenger electric vehicles, has been developed.

The heat pump system for reducing heating power consumption of the existing passenger electric vehicle (EV) constitutes a heating cycle through refrigerant direction switching using an inside capacitor and a three-way valve in the HVAC. Such a method increases the cost by requiring an extra space and additional parts for the inside condenser in the HVAC.

However, in the case of a small EV bus, it is difficult to apply the above method because there is a structural difference from a passenger EV.

In addition, even when the conventional heat pump HVAC is applied to a passenger seat for heating and cooling of the small EV bus, a separate evaporator (EVAP) and a condenser for heating and cooling should be added so that there is a disadvantage in that a cost burden is further increased.

The contents described in the BACKGROUND section are provided to aid understanding of the background of the present disclosure and may include what is not previously known to those having ordinary skill in the art to which the present disclosure pertains.

### SUMMARY

An embodiment of the present disclosure is directed to a heating, ventilation, and air conditioner (HVAC) of an electric vehicle (e.g., an electric bus), which is capable of providing efficient heating and cooling to a small bus without adding an inside capacitor and a separate evaporator.

Other objects and advantages of the present disclosure can be understood by the following description and become apparent with reference to the embodiments of the present disclosure. Also, it is obvious to those having ordinary skill in the art to which the present disclosure pertains that the objects and advantages of the present disclosure can be realized by the means as claimed and combinations thereof.

In accordance with an embodiment of the present disclosure, a heating, ventilation, and air conditioner (HVAC) of an electric vehicle includes: a compressor configured to compress a refrigerant, and a four-way reversing valve connected to four flow paths including a first flow path connected to a discharge end of the compressor and a second flow path connected to a suction end of the compressor. The HVAC further includes: a first heat exchanger connected to the four-way reversing valve and configured to operate as a condenser or an evaporator according to a circulation direction of the refrigerant, and a second heat exchanger of which one end is connected to the first heat exchanger and the other end is connected to the four-way reversing valve. The second heat exchanger operates as a condenser or an evaporator according to the circulation direction of the refrigerant. In particular, wherein the four-way reversing valve circulates the refrigerant introduced through the first flow path connected to the discharge end of the compressor to the first heat exchanger or the second heat exchanger under the control of a controller.

In addition, the four-way reversing valve may circulate the refrigerant introduced from the first heat exchanger or the second heat exchanger through the second flow path connected to the suction end of the compressor under the control of the controller.

Here, air by a blower provided in the first heat exchanger may be blown through an air outlet of a driver seat of the vehicle

In addition, the HVAC may further include a positive temperature coefficient (PTC) heater provided at a rear stage of the first heat exchanger, and a flow path from the first heat exchanger to the PTC heater may be openable and closable.

In addition, the HVAC may further include a first control valve configured to open and close a flow path from the four-way reversing valve to the first heat exchanger under the control of the controller or configured to operate as an expansion valve.

In addition, the HVAC may further include a second control valve provided on a flow path from the first heat exchanger to the second heat exchanger and configured to operate as an expansion valve.

Meanwhile, the second heat exchanger may exchange heat with cooling water circulating in a flow path for cooling power electric (PE) parts.

In addition, the HVAC may further include an air cooled condenser provided between the first control valve and the second control valve and disposed on an outer side of the vehicle, and a three-way valve configured to connect a flow path between the first control valve and the second control valve and selectively open and close a flow path to the air cooled condenser.

In addition, when a cooling mode is controlled by the controller, the three-way valve may be controlled to open the flow path to the air cooled condenser.

Furthermore, the HVAC may further include a third heat exchanger arranged in parallel with the first heat exchanger. The third heat exchanger is connected to the four-way reversing valve and operates as a condenser or an evaporator according to the circulation direction of the refrigerant.

In addition, the HVAC may further include a third control valve configured to open and close a flow path from the four-way reversing valve to the third heat exchanger under the control of the controller or configured to operate as an expansion valve.

Thus, when a heating mode is controlled by the controller, the four-way reversing valve may be controlled to allow the refrigerant to circulate from the four-way reversing valve to the first heat exchanger or the third heat exchanger. In addition, opening and closing of the first control valve and the third control valve may be controlled, and the second control valve may be operated as an expansion valve.

In addition, when a cooling mode is controlled by the controller, the four-way reversing valve may be controlled to allow the refrigerant to circulate from the four-way reversing valve to the second heat exchanger, and the first control valve and the third control valve may be operated as expansion valves.

In addition, when a deforesting mode is controlled by the controller, the four-way reversing valve may be controlled to allow the refrigerant to circulate from the four-way reversing valve to the second heat exchanger, the first control valve is operated as an expansion valve, and a flow path from the first heat exchanger to the PTC heater provided at a rear stage of the first heat exchanger is controlled to be closed.

In addition, air by a blower provided in the third heat exchanger may be blown through an air outlet provided in an indoor roof of a passenger seat of the electric vehicle.

Meanwhile, the HVAC may further include a battery chiller arranged in parallel with the first heat exchanger. The battery chiller is connected to the four-way reversing valve and configured to exchange heat with a refrigerant circulating in a battery cooling flow path, and a chiller control valve provided at a front stage of the battery chiller.

In addition, when a battery cooling mode is controlled by the controller, the four-way reversing valve may be controlled to allow the refrigerant to circulate from the four-way reversing valve to the second heat exchanger, and the chiller control valve may be operated as an expansion valve.

In accordance with another embodiment of the present disclosure, a heating, ventilation, and air conditioner (HVAC) of an electric vehicle includes: a first heat exchanger configured to be operated as a condenser or an evaporator according to a circulation direction of a refrigerant and disposed at a front side of a vehicle in a driver seat; a second heat exchanger connected to the first heat exchanger, configured to be operated as a condenser or an evaporator according to the circulation direction of the refrigerant, and disposed on an outer side of the vehicle; and a third heat exchanger connected in parallel with the first heat exchanger, configured to be operated as a condenser or an evaporator according to the circulation direction of the refrigerant, and disposed at a roof of a passenger seat of the electric vehicle. The HVAC further includes: a passenger side heater disposed on a passenger seat floor for heating the passenger seat, and a four-way valve connected to a suction end and a discharge end of a compressor configured to compress the refrigerant and connected to four flow paths to the first heat exchanger and the second heat exchanger.

In addition, the second heat exchanger may exchange heat with cooling water circulating in a flow path for cooling power electric (PE) parts.

In addition, the HVAC may further include: an air-cooled condenser provided between the first heat exchanger and the second heat exchanger and disposed on an outer side of the vehicle, and a three-way valve configured to connect a flow path between the first heat exchanger and the second heat exchanger and selectively open and close a flow path to the air-cooled condenser.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic diagram illustrating an air conditioning method by a heating, ventilation, and air conditioner (HVAC) of an electric bus according to an embodiment of the present disclosure;

FIG. 2 is a diagram illustrating the HVAC of an electric bus according to an embodiment of the present disclosure;

FIGS. 3 to 6 are diagrams illustrating heating modes by the HVAC of an electric bus according to embodiments of the present disclosure.

FIGS. 7 to 12 are diagrams illustrating cooling modes by the HVAC of an electric bus according to embodiments of the present disclosure.

The drawings described herein are for illustration purposes only and are not intended to limit the scope of the present disclosure in any way.

### DESCRIPTION OF SPECIFIC EMBODIMENTS

In order to fully understand the present disclosure and operational advantages of the present disclosure and objects attained by practicing the present disclosure, reference should be made to the accompanying drawings that illustrate embodiments of the present disclosure and to the description in the accompanying drawings.

In describing embodiments of the present disclosure, a description of known technologies or repeated descriptions may be reduced or omitted to avoid unnecessarily obscuring the gist of the present disclosure.

When a component, device, element, or the like of the present disclosure is described as having a purpose or performing an operation, function, or the like, the component, device, or element should be considered herein as being “configured to” meet that purpose or to perform that operation or function.

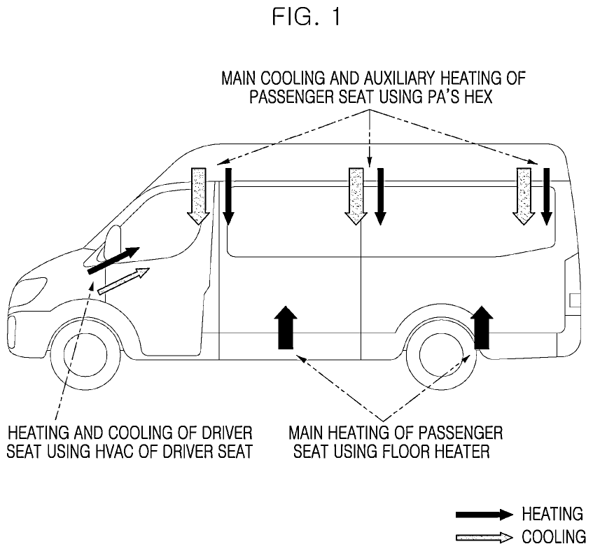

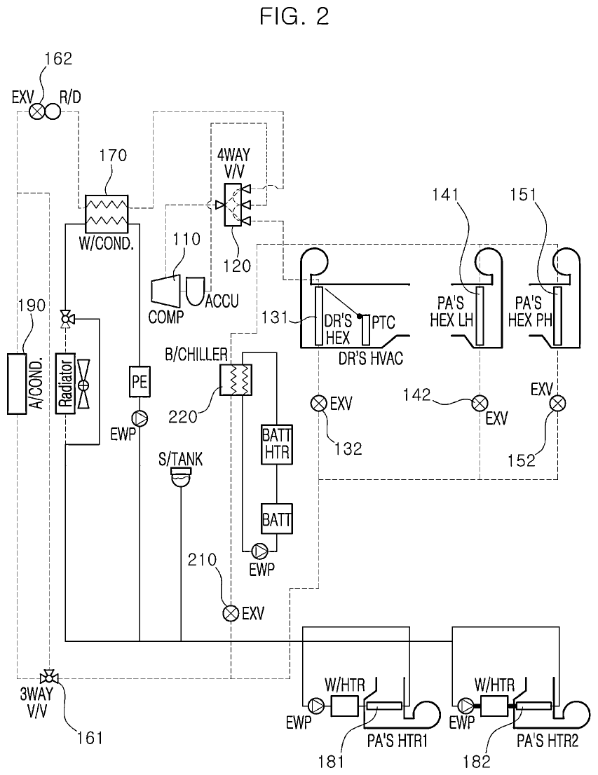

FIG. 1 is a schematic diagram illustrating an air conditioning method by a heating, ventilation, and air conditioner (HVAC) of an electric bus according to an embodiment of the present disclosure, and FIG. 2 is a diagram illustrating the HVAC of an electric bus according to an embodiment of the present disclosure.

Hereinafter, the HVAC of an electric bus according to one embodiment of the present disclosure is described with reference to FIGS. 1 and 2.

The HVAC is easy to apply to a small electric bus. The HVAC includes: one compressor 110, a four-way reversing valve 120 installed on an entrance side (discharge & suction) of the one compressor 110 and configured to change a direction of a refrigerant, a water-cooled condenser, and an air-cooled condenser for dissipating heat of a refrigerant on an outer side of the vehicle, and a heat exchanger for a driver seat and a positive temperature coefficient (PTC) heater installed for indoor heating and cooling.

In a small bus, a height of a passenger seat is high and a volume is large, and thus it is difficult to perform effective heating and cooling only using a HVAC of the driver seat and a heater of a passenger seat floor.

Therefore, a floor heater (a water heating heater or PTC heater) for heating the passenger seat and a separate heat exchanger for auxiliary heating and cooling for the passenger seat are provided in an indoor roof, and a heat exchanger and a blower for cooling and heating (a heat pump) are added to a rear roof of the passenger seat to increase heating and cooling efficiency.

In particular, the present disclosure has a structure in which a heat exchanger for the driver seat and a heat exchanger for the passenger seat are converted into a cooling and heating heat exchanger according to a direction change of the refrigerant of a four-way valve.

In other words, according to a movement of the four-way reversing valve 120 in a front-rear direction, a controller may control an entrance of the refrigerant discharged from and suctioned into the compressor 110 to convert roles of a first heat exchanger 131 on the driver seat, a third heat exchanger 141 on the passenger seat, and a fourth heat exchanger 151 into a role of a condenser or an evaporator.

In this way, the present disclosure may maximally use one compressor and a required minimum configuration to be suitable for a small electric bus, thereby efficiently operating heating and cooling.

Meanwhile, a passenger seat floor heater, which is described below, may be changed to a PTC heater.

An illustrated cooling water surge tank S/TANK may be commonly used for PE cooling, battery cooling, and a cooling water system of the passenger seat heater.

Hereinafter, cooling and heating modes of the HVAC of an electric bus according to the present disclosure is described.

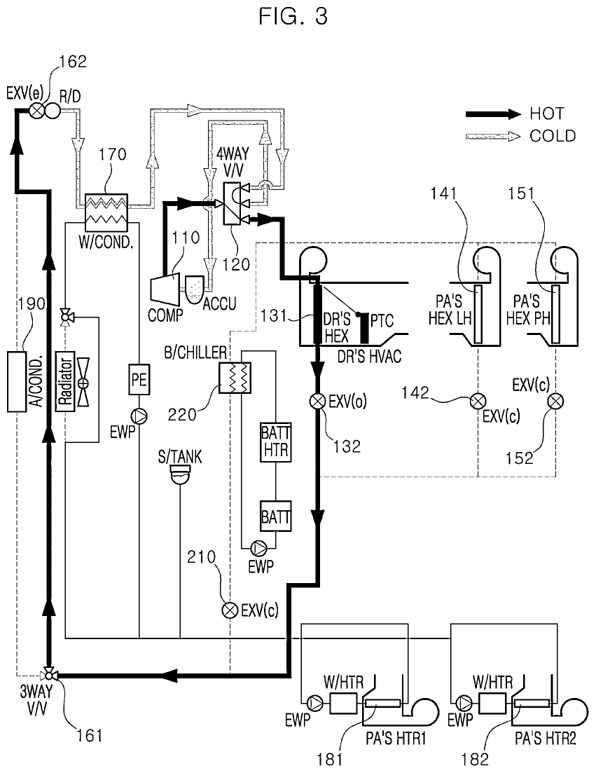

FIGS. 3 to 6 are diagrams illustrating heating modes by the HVAC of an electric bus according to the present disclosure.

First, FIG. 3 shows a heat pump mode in which only the driver seat is heated.

The four-way reversing valve 120 is connected to a discharge end of the compressor 110 which compresses the refrigerant into a high-temperature and high-pressure gas.

A flow path of an inlet of the four-way reversing valve 120 is connected to the discharge end of the compressor 110, and three flow paths at an outlet are connected to a suction end of the compressor 110, a first heat exchanger 131, a second heat exchanger 170, respectively, so that the controller controls two outlets to be closed and controls one outlet to be selectively opened.

In addition, the three flow paths on the outlet side simultaneously serve as the inlets, and thus a refrigerant introduced into any one flow path among the outlets flows into the suction end of the compressor 110 through the outlet connected to the inlet of the compressor 110.

When the heat pump mode for heating only the driver seat is selected, the controller connects the outlet of the four-way reversing valve 120 to the first heat exchanger 131.

The first heat exchanger 131 is a heat exchanger DR's HEX of the driver seat, serves as a condenser for condensing a high-temperature and high-pressure refrigerant from the compressor 110, and blows hot air to be blown by a blower through an air outlet of the driver seat.

In addition, air passing through the first heat exchanger 131 may be blown through the PTC heater.

A first control valve 132, a three-way valve 161, and a second control valve 162 are provided at a rear stage of the first heat exchanger 131, and the refrigerant passes through the above valves to flow into the second heat exchanger 170.

The first control valve 132 may serve as a simplified opening/closing or expansion valve EXV. Here, “o” (open) indicates open, “c” (close) indicates close, and “e” indicates to serve as an expansion valve, and the same marks are applied to other valves below.

In other words, in the mode of FIG. 3, the first control valve 132 of the rear stage of the first heat exchanger 131 is opened, and the third control valve 142 and the fourth control valve 152 are closed so that the refrigerant passes through only the first heat exchanger 131 of the driver seat.

An inlet of the three-way valve 161 is connected to the first heat exchanger 131, an outlet thereof is connected to the second heat exchanger 170 and the air-cooled condenser 190, and in the mode of FIG. 3, the three-way valve 161 is connected to the second heat exchanger 170.

Here, the inlet and the outlet oppositely act when a direction of the refrigerant is reversed.

The second control valve 162 in a front stage of the second heat exchanger 170 serves as an expansion valve e, and a low-temperature and high-pressure liquid refrigerant passing through the first heat exchanger 131 becomes a low-temperature and low-pressure liquid through the second control valve 162 to flow into the second heat exchanger 170.

Here, expressions of the front stage and the rear stage below are expressions on the basis of the refrigerant, and the front stage and the rear stage may be reversed according to a circulation direction of the refrigerant.

The second heat exchanger 170 serves as an evaporator for evaporating a low-temperature and low-pressure liquid into a low-temperature and low-pressure gas and exchanges heat with cooling water for cooling PE parts. In this case, as shown in the drawings, the cooling water for cooling the PE parts is controlled so as not to pass through a radiator.

Thereafter, the low-temperature and low-pressure gaseous refrigerant heat-exchanged by the second heat exchanger 170 flows into the suction end of the compressor 110 again through the four-way reversing valve 120 so that the refrigerant circulates.

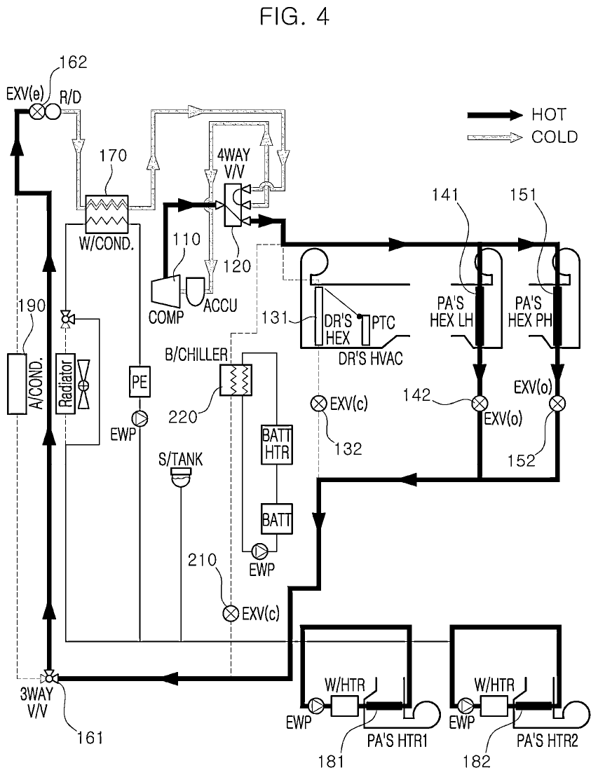

FIG. 4 shows a heat pump mode in which only the passenger seat is heated. In the following mode, the same description as that of the previously described mode has been omitted herein.

The refrigerant compressed into a high-temperature and high-pressure gas by the compressor 110 flows into the inlet of the four-way reversing valve 120 to circulate through outlets of the first heat exchanger 131, the third heat exchanger 141, and the fourth heat exchanger 151.

Here, when the heat pump mode in which only the passenger seat is heated is selected, the first control valve 132 at the rear stage of the first heat exchanger 131 is controlled to become a closed state (c), and the third control valve 142 at the rear stage of the third heat exchanger 141 and the fourth control valve 152 at the rear stage of the fourth heat exchanger 151 are controlled to become an open state (o).

Therefore, the third heat exchanger 141 becomes a left heat exchanger at the passenger seat (“PA's HEX. LH”) and the fourth heat exchanger 151 becomes a right heat exchanger at the passenger seat (“PA's HEX. RH”), thereby serving as condensers for condensing the high-temperature and high-pressure refrigerant from the compressor 110, and the blower blows hot air through an air outlet provided in an indoor roof of the passenger seat.

A three-way valve 161 and a second control valve 162 are provided at the rear stages of the third heat exchanger 141 and the fourth heat exchanger 151, and the refrigerant passes through the above valves to flow into the second heat exchanger 170.

Flow paths to the third heat exchanger 141 and the fourth heat exchanger 151 are formed in parallel with a flow path to the first heat exchanger 131, and a first passenger side heater 181 and a second passenger side heater 182 are provided on a flow path to the second heat exchanger 170 so that hot air is blown through the passenger side floor equipped with the first passenger side heater 181 and the second passenger side heater 182.

The refrigerant circulates through the three-way valve 161 which is opened to the second heat exchanger 170, and the second control valve 162 at the front stage of the second heat exchanger 170 serves as an expansion valve “e” so that a low-temperature and high-pressure liquid refrigerant passing through the third heat exchanger 141 and the first heat exchanger 131 becomes a low-temperature and low-pressure liquid through the second control valve 162 to flow into the second heat exchanger 170.

The second heat exchanger 170 serves as an evaporator which heat-exchanges with the cooling water of the PE parts to evaporate the low-temperature and low-pressure liquid into a low-temperature and low-pressure gas.

Thereafter, the low-temperature and low-pressure gaseous refrigerant heat-exchanged by the second heat exchanger 170 flows into the inlet of the compressor 110 again through the four-way reversing valve 120 so that the refrigerant circulates.

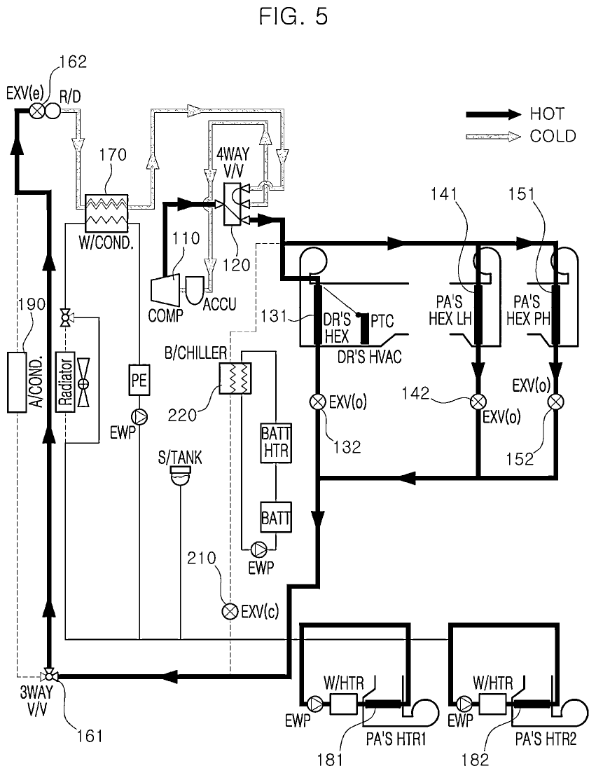

FIG. 5 shows a heat pump mode in which both of the driver seat and the passenger seat are heated.

The refrigerant compressed into a high-temperature and high-pressure gas by the compressor 110 flows into the inlet of the four-way reversing valve 120 to circulate through the outlets of the first heat exchanger 131, the third heat exchanger 141, and the fourth heat exchanger 151 which are connected in parallel.

Here, when the heat pump mode in which both of the driver seat and the passenger seat are heated is selected, all of the first control valve 132 at the rear stage of the first heat exchanger 131, the third control valve 142 at the rear stage of the third heat exchanger 141, and the fourth control valve 152 at the rear stage of the fourth heat exchanger 151 are controlled to become an open state (o).

Therefore, all of the first heat exchanger 131, the third heat exchanger 141, and the fourth heat exchanger 151 serve as condensers for condensing the high-temperature and high-pressure refrigerant from the compressor 110, and the blower blows hot air through air outlets provided in the driver seat, the indoor roof of the passenger seat, and the passenger seat floor.

In addition, air passing through the first heat exchanger 131 may be blown through the PTC heater.

The three-way valve 161 is controlled to be open toward the second heat exchanger 170, and the refrigerant flows into the second heat exchanger 170 through the three-way valve 161 and the second control valve 162.

The second control valve 162 at the front stage of the second heat exchanger 170 serves as an expansion valve “e” so that a low-temperature and high-pressure liquid refrigerant passing through the first heat exchanger 131, the third heat exchanger 141, and the fourth heat exchanger 151 becomes a low-temperature and low-pressure liquid through the second control valve 162 to flow into the second heat exchanger 170.

Thus, the second heat exchanger 170 serves as an evaporator which heat-exchanges with the cooling water of the PE parts to evaporate the low-temperature and low-pressure liquid into a low-temperature and low-pressure gas.

Thereafter, the low-temperature and low-pressure gaseous refrigerant heat-exchanged by the second heat exchanger 170 flows into the inlet of the compressor 110 again through the four-way reversing valve 120 so that the refrigerant circulates.

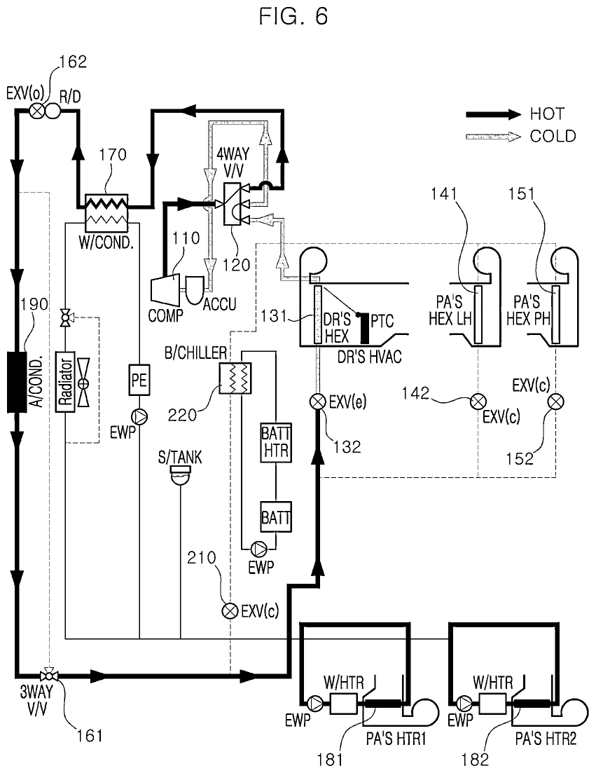

FIG. 6 shows a driver seat defrosting mode which is a mode for removing frost when a window glass is cloudy with water droplets or frost.

The refrigerant compressed into a high-temperature and high-pressure gas by the compressor 110 flows into the inlet of the four-way reversing valve 120 to circulate through the outlet of the second heat exchanger 170. To this end, the second control valve 162 at the rear end of second heat exchanger 170 is controlled to be opened.

In addition, since the flow path at the inlet of the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

The first control valve 132 serves as an expansion valve e, and the third control valve 142 and the fourth control valve 152 are controlled to be closed so that the refrigerant circulates to the first heat exchanger 131 through the first control valve 132.

In this case, hot air is blown through a passenger seat floor by a first passenger side heater 181 and a second passenger side heater 182 which are provided on a flow path to the first heat exchanger 131.

The low-temperature and low-pressure liquid refrigerant passing through the first control valve 132 at the front state of the first heat exchanger 131 flows into the first heat exchanger 131, and the first heat exchanger 131 serves as an evaporator for evaporating a low-temperature and low-pressure liquid into a low-temperature and low-pressure gas.

In addition, cold air passing through the first heat exchanger 131 is blown through the PTC heater to be controlled to allow the driver seat to be defrosted through low-temperature dry air.

Thereafter, the low-temperature and low-pressure gaseous refrigerant heat-exchanged by the first heat exchanger 131 flows into the inlet of the compressor 110 again through the four-way reversing valve 120 so that the refrigerant circulates.

As described above, when defrosting is required in winter season, because a cycle of an air conditioner mode (cooling mode) is operated and heating is performed using the PTC heater, a separate pipe and a separate valve are not required as in the related art.

As described above, according to the present disclosure, since the heat exchanger in the HVAC serves as an evaporator or a condenser using the four-way reversing valve, a separate inner capacitor for the heat pump is not required so that a size of the HVAC can be reduced.

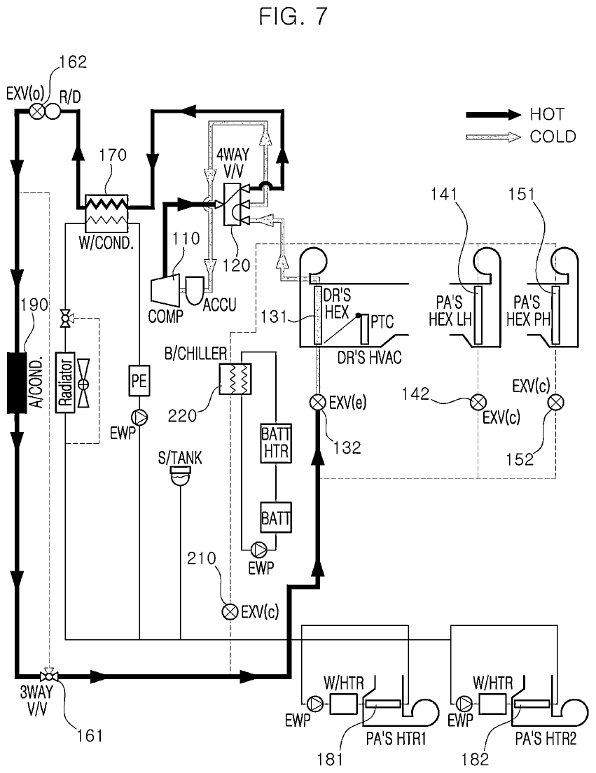

FIGS. 7 to 11 are diagrams illustrating cooling modes by the HVAC of an electric bus according to the present disclosure.

First. FIG. 7 shows a cooling mode in which only the driver seat is cooled.

The refrigerant compressed into a high-temperature and high-pressure gas by the compressor 110 flows into the inlet of the four-way reversing valve 120 to circulate through the outlet of the second heat exchanger 170. To this end, the second control valve 162 at the rear end of second heat exchanger 170 is controlled to be opened.

In addition, since the inlet of the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

The first control valve 132 serves as an expansion valve “e”, and the third control valve 142 and the fourth control valve 152 are controlled to be closed so that the refrigerant circulates to the first heat exchanger 131 through the first control valve 132 at the front stage of the first heat exchanger 131.

The low-temperature and low-pressure liquid refrigerant passing through the first control valve 132 flows into the first heat exchanger 131, and the first heat exchanger 131 serves as an evaporator for evaporating a low-temperature and low-pressure liquid into a low-temperature and low-pressure gas.

In this case, the cold air passing through the first heat exchanger 131 is blown by controlling the flow path so that the cold air does not pass through the PTC heater, and as a result, the cold air is blown to the air outlet of the driver seat.

Thereafter, the low-temperature and low-pressure gaseous refrigerant heat-exchanged by the first heat exchanger 131 flows into the inlet of the compressor 110 again through the four-way reversing valve 120 so that the refrigerant circulates.

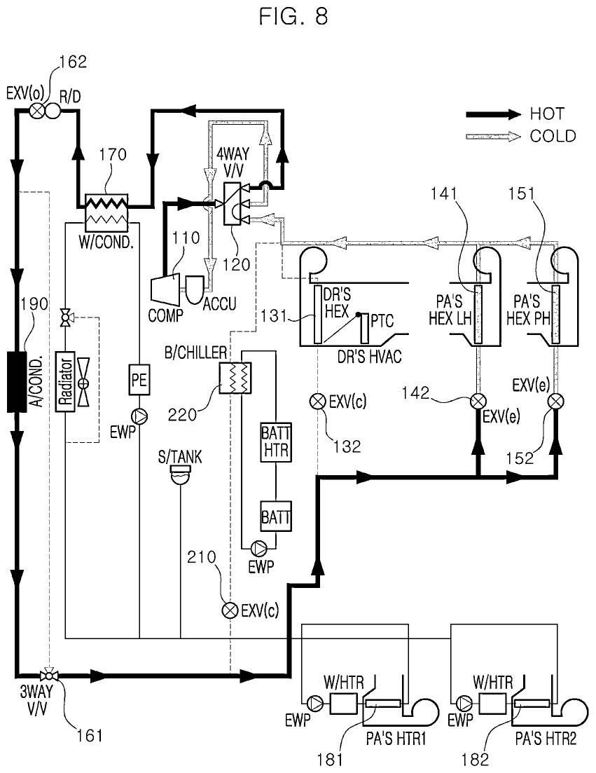

FIG. 8 shows a cooling mode in which only the passenger seat is cooled.

The refrigerant compressed into a high-temperature and high-pressure gas by the compressor 110 flows into the inlet of the four-way reversing valve 120 to circulate through the outlet of the second heat exchanger 170. To this end, the second control valve 162 is controlled to be opened.

In addition, since the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

In the cooling mode in which only the passenger seat is cooled, the first control valve 132 is controlled to be closed (c), and the third control valve 142 and the fourth control valve 152 are controlled as expansion valves “e” so that refrigerant passes through the third control valve 142 and the fourth control valve 152 to circulate to the third heat exchanger 141 and the fourth heat exchanger 151.

The low-temperature and low-pressure liquid refrigerant passing through the third control valve 142 and the fourth control valve 152 flows into the third heat exchanger 141 and the fourth heat exchanger 151, and the third heat exchanger 141 and the fourth heat exchanger 151 serve as evaporators for evaporating a low-temperature and low-pressure liquid to a low-temperature and low-pressure gas.

Therefore, the cold air is blown through the roof of the passenger seat.

Thereafter, the low-temperature and low-pressure gaseous refrigerant heat-exchanged by the first heat exchanger 131 flows into the inlet of the compressor 110 again through the four-way reversing valve 120 so that the refrigerant circulates.

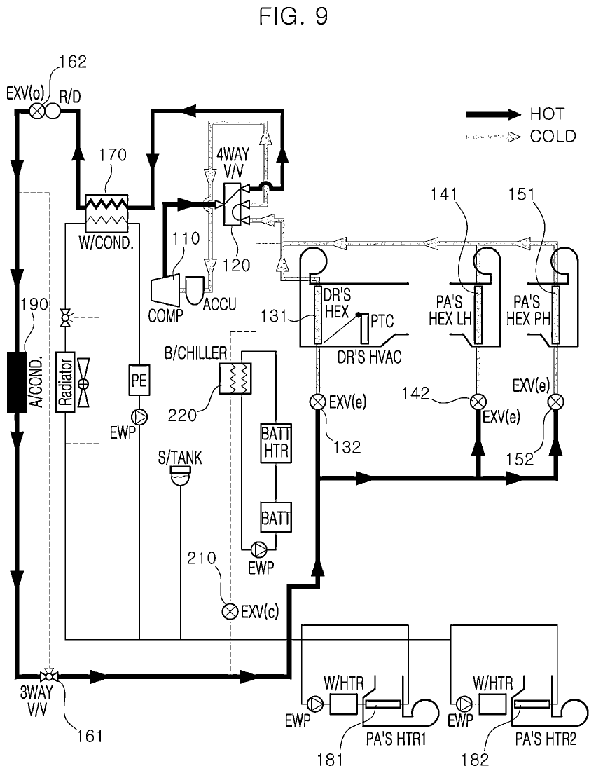

FIG. 9 shows a cooling mode in which both of the driver seat and the passenger seat are cooled.

The refrigerant compressed into a high-temperature and high-pressure gas by the compressor 110 flows into the inlet of the four-way reversing valve 120 to circulate through the outlet of the second heat exchanger 170. To this end, the second control valve 162 is controlled to be opened.

In addition, since the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

In the cooling mode in which the driver seat and the passenger seat are cooled, all of the first control valve 132, the third control valve 142, and the fourth control valve 152 are controlled as expansion valves e so that refrigerant passes through the first control valve 132, the third control valve 142, and the fourth control valve 152 to circulate to the first heat exchanger 131, the third heat exchanger 141, and the fourth heat exchanger 151.

The low-temperature and low-pressure liquid refrigerant passing through the first control valve 132, the third control valve 142, and the fourth control valve 152 flows into the first heat exchanger 131, the third heat exchanger 141, and the fourth heat exchanger 151. The first heat exchanger 131, the third heat exchanger 141, and the fourth heat exchanger 151 serve as evaporators for evaporating a low-temperature and low-pressure liquid to a low-temperature and low-pressure gas.

Therefore, the cool air is blown through the roofs of the driver seat and the passenger seat.

Thereafter, the low-temperature and low-pressure gaseous refrigerant heat-exchanged by the first heat exchanger 131 flows into the inlet of the compressor 110 again through the four-way reversing valve 120 so that the refrigerant circulates.

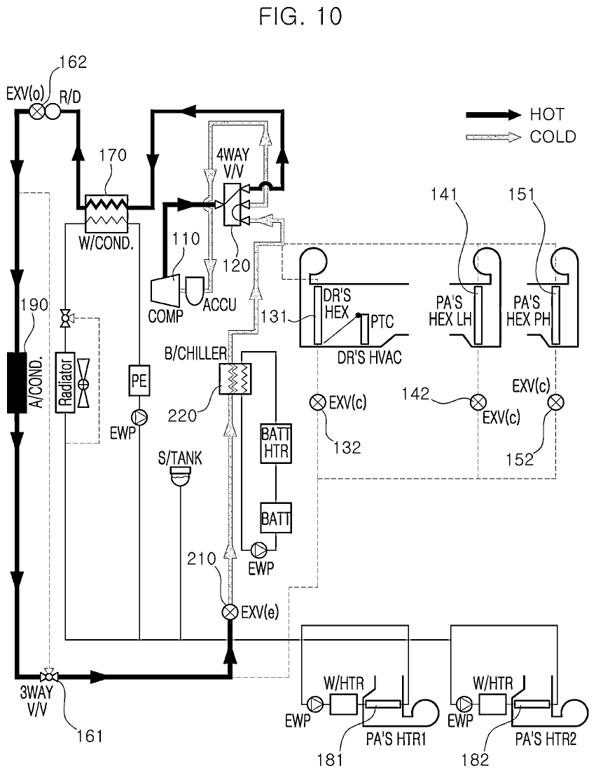

Meanwhile, FIG. 10 shows a cooling mode in which only battery cooling is performed.

The refrigerant compressed into a high-temperature and high-pressure gas by the compressor 110 flows into the inlet of the four-way reversing valve 120 to circulate through the outlet of the second heat exchanger 170. To this end, the second control valve 162 is controlled to be opened.

In addition, since the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

A battery chiller B/CHILLER 220 for battery cooling is arranged in parallel with the first heat exchanger 131, and a chiller control valve 210 provided at a front stage of the battery chiller 220 for a mode performing only the battery cooling is controlled as an expansion valve “e”.

On the other hand, the first control valve 132, the third control valve 142, and the fourth control valve 152 are controlled to be closed (c).

Accordingly, the low-temperature and low-pressure liquid refrigerant passing through the chiller control valve 210 flows into the battery chiller 220, and the battery chiller 220 exchanges heat with the refrigerant circulating in a battery cooling flow path.

Thereafter, the low-temperature and low-pressure gaseous refrigerant heat-exchanged by the battery chiller 220 flows into the inlet of the compressor 110 again through the four-way reversing valve 120 so that the refrigerant circulates.

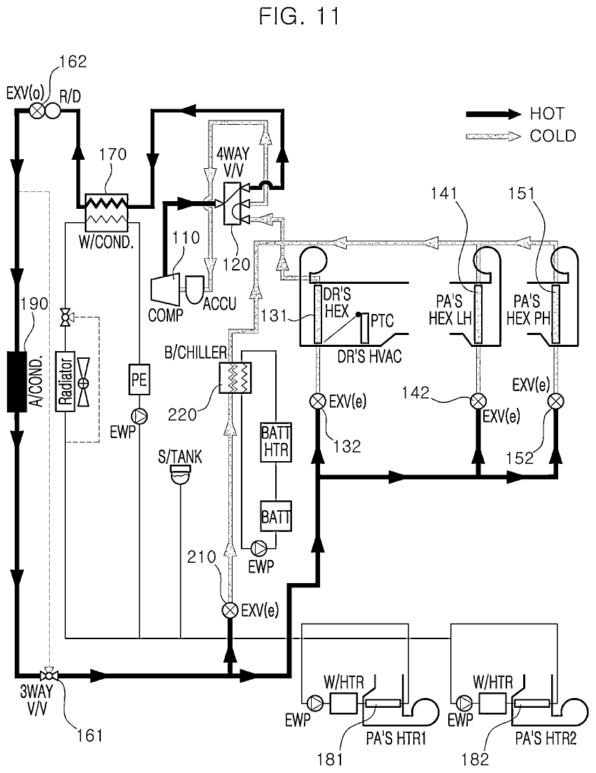

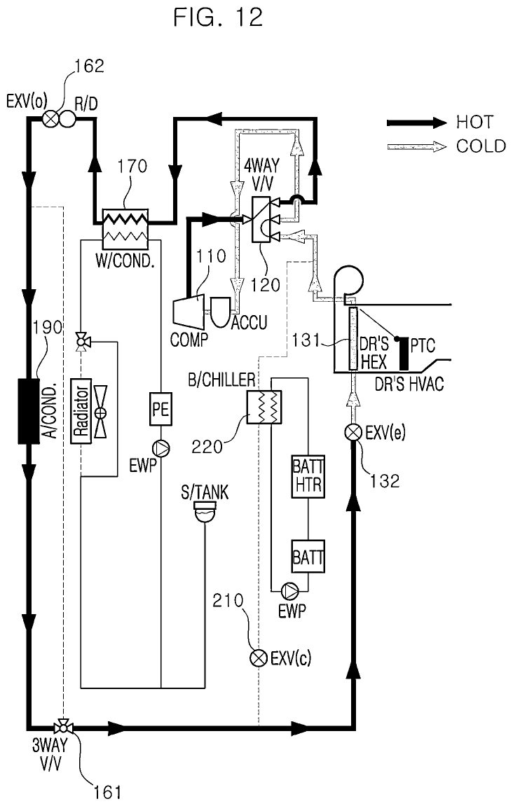

FIG. 11 shows a cooling mode in which all of cooling of both the driver seat and the passenger seat and battery cooling are performed.

The refrigerant compressed into a high-temperature and high-pressure gas by the compressor 110 flows into the inlet of the four-way reversing valve 120 to circulate through the outlet of the second heat exchanger 170. To this end, the second control valve 162 is controlled to be opened.

In addition, because the three-way valve 161 is controlled to be opened toward the air cooled condenser 190, the refrigerant passing through the second heat exchanger 170 circulates through the air cooled condenser 190.

The second heat exchanger 170 and the air cooled condenser 190 condense the high-temperature and high-pressure gas refrigerant into a low-temperature and high-pressure liquid refrigerant.

The second heat exchanger 170 exchanges heat with the cooling water for cooling the PE parts and, as shown in the drawings, is controlled to exchange heat with the cold cooling water passing through the radiator.

For the cooling of both the driver seat and the passenger seat and the battery cooling, all of the chiller control valve 210, the first control valve 132, the third control valve 142, and the fourth control valve 152 are controlled as expansion valves “e”.

Accordingly, the low-temperature and low-pressure liquid refrigerant passing through the chiller control valve 210, the first control valve 132, the third control valve 142, and the fourth control valve 152 flows into the battery chiller 220, the first heat exchanger 131, the third heat exchanger 141, and the fourth heat exchanger 151, The battery chiller 220 exchanges heat with the refrigerant circulating in the battery cooling flow path.

In addition, the first heat exchanger 131, the third heat exchanger 141, and the fourth heat exchanger 151 serve as evaporators for evaporating a low-temperature and low-pressure liquid to a low-temperature and low-pressure gas.

Therefore, the cool air is blown through the loops of the driver seat and the passenger seat.

Thereafter, the low-temperature and low-pressure gaseous refrigerant heat-exchanged by the battery chiller 220, and the refrigerant heat-exchanged by the first heat exchanger 131, the third heat exchanger 141, and the fourth heat exchanger 151 flow into the inlet of the compressor 110 again through the four-way reversing valve 120 so that the refrigerant circulates.

As described above, according to the HVAC of the present disclosure, by controlling the four-way reversing valve to control the inlet and the outlet of the refrigerant discharged from and suctioned into the compressor, the roles of the heat exchangers provided in the driver seat and the passenger seat are convertible into condensers or evaporators so that it is possible to implement efficient heating and cooling of a small electric bus through one compressor and an efficient configuration.

In accordance with heating, ventilation, and air conditioner (HVAC) of an electric bus according to the present disclosure, one compressor and a four-way reversing valve are used so that heating and cooling of a small electric bus can be efficiently operated.

In addition, waste heat for battery cooling is used so that sufficient heating and cooling of a passenger seat can be possible.

While the present disclosure has been described with reference to the accompanying drawings, it should be apparent to those having ordinary skill in the art that various changes and modifications can be made without departing from the spirit and scope of the present disclosure without being limited to the embodiments disclosed herein. Accordingly, it should be noted that such alternations or modifications fall within the scope of the present disclosure.

What is claimed is:

1. A heating, ventilation, and air conditioner (HVAC) of an electric vehicle, the HVAC comprising:
a compressor configured to compress a refrigerant;
a four-way reversing valve connected to four flow paths including: a first flow path connected to a discharge end of the compressor and a second flow path connected to a suction end of the compressor;
a first heat exchanger connected to the four-way reversing valve and configured to operate as a condenser or an evaporator based on a circulation direction of the refrigerant; and
a second heat exchanger including: a first end connected to the first heat exchanger and a second end connected to the four-way reversing valve, the second heat exchanger configured to operate as a condenser or an evaporator according to the circulation direction of the refrigerant,
wherein the four-way reversing valve is configured to circulate the refrigerant introduced through the first flow path to the first heat exchanger or the second heat exchanger under a control of a controller.

2. The HVAC of claim 1, wherein the four-way reversing valve circulates the refrigerant introduced from the first heat exchanger or the second heat exchanger through the second flow path connected to the suction end of the compressor under the control of the controller.

3. The HVAC of claim 2, wherein air by a blower provided in the first heat exchanger is blown through an air outlet of a driver seat of the electric vehicle.

4. The HVAC of claim 3, further comprising:
a positive temperature coefficient (PTC) heater provided at a rear stage of the first heat exchanger,
wherein a flow path from the first heat exchanger to the PTC heater is openable and closable.

5. The HVAC of claim 2, further comprising:
a first control valve configured to open and close a flow path from the four-way reversing valve to the first heat exchanger under the control of the controller or configured to operate as an expansion valve.

6. The HVAC of claim 5, further comprising:
a second control valve provided on a flow path from the first heat exchanger to the second heat exchanger and configured to operate as an expansion valve.

7. The HVAC of claim 6, wherein the second heat exchanger exchanges heat with cooling water circulating in a flow path for cooling power electric (PE) parts.

8. The HVAC of claim 6, further comprising:
an air cooled condenser provided between the first control valve and the second control valve and disposed on an outer side of the electric vehicle; and
a three-way valve configured to connect a flow path between the first control valve and the second control valve and configured to selectively open and close a flow path to the air cooled condenser.

9. The HVAC of claim 8, wherein, when a cooling mode is controlled by the controller, the three-way valve is controlled to open the flow path to the air cooled condenser.

10. The HVAC of claim 6, further comprising:
a third heat exchanger arranged in parallel with the first heat exchanger and connected to the four-way reversing valve, the third heat exchanger configured to operate as a condenser or an evaporator according to the circulation direction of the refrigerant.

11. The HVAC of claim 10, further comprising:
a third control valve configured to open and close a flow path from the four-way reversing valve to the third heat exchanger under the control of the controller or configured to operate as an expansion valve.

12. The HVAC of claim 11, wherein:
when a heating mode is controlled by the controller, the four-way reversing valve is controlled to allow the refrigerant to circulate from the four-way reversing valve to the first heat exchanger or the third heat exchanger;
opening and closing of the first control valve and the third control valve are controlled; and
the second control valve is operated as an expansion valve.

13. The HVAC of claim 11, wherein:
when a cooling mode is controlled by the controller, the four-way reversing valve is controlled to allow the refrigerant to circulate from the four-way reversing valve to the second heat exchanger; and
the first control valve and the third control valve are operated as expansion valves.

14. The HVAC of claim 11, wherein:
when a deforesting mode is controlled by the controller, the four-way reversing valve is controlled to allow the refrigerant to circulate from the four-way reversing valve to the second heat exchanger;
the first control valve is operated as an expansion valve; and
a flow path from the first heat exchanger to a positive temperature coefficient (PTC) heater provided at a rear stage of the first heat exchanger is controlled to be closed.

15. The HVAC of claim 11, wherein air by a blower provided in the third heat exchanger is blown through an air outlet provided in an indoor roof of a passenger seat of the electric vehicle.

16. The HVAC of claim 11, further comprising:
a battery chiller arranged in parallel with the first heat exchanger and connected to the four-way reversing valve, the battery chiller configured to exchange heat with a refrigerant circulating in a battery cooling flow path; and
a chiller control valve provided at a front stage of the battery chiller.

17. The HVAC of claim 16, wherein:
when a battery cooling mode is controlled by the controller, the four-way reversing valve is controlled to allow the refrigerant to circulate from the four-way reversing valve to the second heat exchanger; and
the chiller control valve is operated as an expansion valve.

18. A heating, ventilation, and air conditioner (HVAC) of an electric vehicle, the HVAC comprising:
a first heat exchanger configured to be operated as a condenser or an evaporator based on a circulation direction of a refrigerant, wherein the first heat exchanger is disposed at a front side of a vehicle in a driver seat of the electric vehicle;
a second heat exchanger connected to the first heat exchanger, configured to be operated as a condenser or an evaporator based on the circulation direction of the refrigerant, wherein the second heat exchanger is disposed on an outer side of the electric vehicle;
a third heat exchanger connected in parallel with the first heat exchanger and configured to be operated as a condenser or an evaporator based on the circulation direction of the refrigerant, wherein the third heat exchanger is disposed at a roof of a passenger seat of the electric vehicle;
a passenger side heater disposed on a passenger seat floor for heating the passenger seat; and
a four-way reversing valve connected to a suction end and a discharge end of a compressor configured to compress the refrigerant and connected to four flow paths to the first heat exchanger and the second heat exchanger.

19. The HVAC of claim 18, wherein the second heat exchanger exchanges heat with cooling water circulating in a flow path for cooling power electric (PE) parts.

20. The HVAC of claim 18, further comprising:
an air cooled condenser provided between the first heat exchanger and the second heat exchanger and disposed on an outer side of the electric vehicle; and
a three-way valve configured to connect a flow path between the first heat exchanger and the second heat exchanger and configured to selectively open and close a flow path to the air cooled condenser.
